(19) United States
(12) Patent Application Publication
(10) Pub. No.: US 2007/0146489 A1
(43) Pub. Date: Jun. 28, 2007

(54) CAMERA HAVING IMAGE-STABILIZING FUNCTION

(75) Inventors: Kosei KOSAKO, Tokyo (JP); Masahiro INAZUKA, Saitama (JP); Kazuki YAZAWA, Tokyo (JP); Shinya SUZUKA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/615,503

(22) Filed: Dec. 22, 2006

(30) Foreign Application Priority Data
Dec. 26, 2005 (JP) P2005-371245

(51) Int. Cl. H04N 5/228

(52) U.S. Cl. 348/208.7

(57) ABSTRACT

A camera having an image-stabilizing function includes an image-stabilizing mechanism which corrects image blur that occurs due to hand shake of the camera; a shutter-release operating member; and an image-stabilizer operating member which is operably movable between an image-stabilizer-activated position and an image-stabilizer-deactivated position, the image-stabilizer operating member being provided separately from the shutter-release operating member on a camera body of the camera. The image-stabilizing mechanism is activated so as to be capable of image stabilization while the image-stabilizer operating member is positioned at the image-stabilizer-activated position. The image-stabilizing mechanism is deactivated so as to be incapable of image stabilization while the image-stabilizer operating member is positioned at the image-stabilizer-deactivated position. The image-stabilizer operating member is biased toward the image-stabilizer-deactivated position so as to be positioned at the image-stabilizer-deactivated position in a free state.

### BACKGROUND OF THE INVENTION

1. Field of the Invention

The present invention relates to a camera having an image-stabilizing function.

2. Description of the Related Art

As an example of a known camera of the related art having an image-stabilizing function (hand-shake correction function), a self-returning button member (image-stabilizer button) is provided, which is freely movable in upward/downward directions and is always biased in a moving direction toward a position so as to protrude from the camera body thereof via a biasing device, and selects an activated/deactivated state of an image-stabilizing operation. In such a camera having an image-stabilizing function, when the image-stabilizing button is depressed once into the camera body by the hand (a finger), an image-stabilizing mechanism provided in the camera is activated so as to be capable of correcting image shake (hand shake). When the user's hand (finger) is released from the image-stabilizing button, the image-stabilizing button again protrudes from the camera body via the biasing force of the biasing device; however, the image-stabilizing mechanism is maintained so as to be capable of performing image-stabilization. If the image-stabilizing button is thereafter depressed once again into the camera body with the user's hand (finger), the image-stabilizing mechanism is deactivated so as to be incapable of performing image stabilization. Hence, the image-stabilizing mechanism is constructed so that each time the image-stabilizing button is depressed, the activation/deactivation of the image-stabilizing operation is alternately carried out in a switching manner, and the set state is maintained until a subsequent depression of the image-stabilizing button.

Furthermore, in another example of a known camera of the related art having an image-stabilizing function, an image-stabilizing button like that described above is not provided, rather, when a shutter-release button is fully depressed, an image-stabilizing mechanism is temporarily activated in operative association with the fully-depression action of the shutter-release button, so that a photographing operation is carried out in a state where the image-stabilizing function is activated.

However, in the former above-mentioned known camera of the related art, the following problem is experienced. Namely, when a photographing operation is carried out in such a camera, upon the photographer (user) depressing the image-stabilizing button once with his/her hand (finger) in order to activate the image-stabilizing mechanism so as to be capable of performing image-stabilization, it is often the case that the user thereafter releases (removes) his/her hand (finger) from the image-stabilizing button. When the user removes his/her hand (finger) from the image-stabilizing button, the image-stabilizing button moves (returns) to a protruding position which is the same position as that when the image-stabilizing mechanism is in a deactivated state and incapable of performing image stabilization. Moreover, (even if hand shake (camera-shake) actually occurs) since the photographic image in which blur has been corrected (having no blur, or the blur is adjusted to a very small amount) is displayed in an LCD panel of the camera as a monitor image, the user does not notice that hand shake has actually occurred. In such circumstances, since the user's attentiveness toward hand shake easily deteriorates, and due to the camera being held by only one hand, the hand shake incurred by the user increases to the extent so as to exceed the image-stabilization capability (hand-shake correction capability) of the image-stabilizing mechanism, so that it becomes difficult to achieve a sharp photographic image having no blur, even if the image-stabilization function is operated.

However, in the latter above-mentioned known camera of the prior art in which the image-stabilizing mechanism temporarily performs image stabilization in operative association with the fully-depression action of the shutter-release button, since an image which does not benefit from the effects of image-stabilization is displayed in the LCD panel of the camera, the user cannot know in advance to what extent the image-stabilizing function is actually performed during a photographing operation.

### SUMMARY OF THE INVENTION

The present invention provides a camera having an image-stabilizing function, in which the user can confirm the extent by which the image-stabilizing function is performed before a photographing operation, and moreover, hand-shake and deterioration in the user's attentiveness toward hand-shake can be effectively prevented.

According to an aspect of the present invention, a camera having an image-stabilizing function is provided, including an image-stabilizing mechanism which corrects image blur that occurs due to hand shake of the camera; a shutter-release operating member; and an image-stabilizer operating member which is operably movable between an image-stabilizer-activated position and an image-stabilizer-deactivated position, the image-stabilizer operating member being provided separately from the shutter-release operating member on a camera body of the camera. The image-stabilizing mechanism is activated so as to be capable of image stabilization while the image-stabilizer operating member is positioned at the image-stabilizer-activated position. The image-stabilizing mechanism is deactivated so as to be incapable of image stabilization while the image-stabilizer operating member is positioned at the image-stabilizer-deactivated position. The image-stabilizer operating member is biased toward the image-stabilizer-deactivated position so as to be positioned at the image-stabilizer-deactivated position in a free state.

It is desirable for the image-stabilizer operating member to be moved so as to protrude upwards from the camera body and moved so as to sink downward into the camera body. The image-stabilizer-deactivated position is a position at which the image-stabilizer operating member protrudes upwards from the camera body. The image-stabilizer-activated position is a position at which the image-stabilizer operating member sinks downward into the camera body.

It is desirable for the image-stabilizer operating member to include a freely slidable member which is linearly slidable along a surface of the camera body, wherein one movement extremity of the slidable member corresponds to the image-stabilizer-deactivated position, and the other movement extremity of the slidable member corresponds to the image-stabilizer-activated position.

It is desirable for the image-stabilizer operating member to include a freely rotatably rotational operating member which is rotatably movable on the camera body, wherein one rotational movement extremity of the rotational operating member corresponds to the image-stabilizer-deactivated position, and the other movement extremity of the rotational operating member corresponds to the image-stabilizer-activated position.

In an embodiment, a camera having an image-stabilizing function is provided, including an image-stabilizing mechanism which corrects image blur that occurs due to hand shake of the camera; a shutter-release operating member; and an image-stabilizer operating member which is operably movable between an image-stabilizer-activated position and an image-stabilizer-deactivated position, the image-stabilizer operating member being provided separately from the shutter-release operating member on a camera body of the camera. The image-stabilizing mechanism is activated so as to be capable of image stabilization while the image-stabilizer operating member is positioned at the image-stabilizer-activated position. The image-stabilizing mechanism is deactivated so as to be incapable of image stabilization while the image-stabilizer operating member is positioned at the image-stabilizer-deactivated position. The shutter-release operating member and the image-stabilizer operating member are provided on the camera body at opposite sides thereof with respect to an approximate center of the camera body.

It is desirable for one and the other of the shutter-release operating member and the image-stabilizer operating member to be provided on right and left end portions of an upper surface of the camera body, in a plan view.

It is desirable for the camera body to include a positional-recognition recess provided thereon in the close vicinity of the image-stabilizer operating member, wherein the positional-recognition recess is tactilely recognizable.

It is desirable for the camera body to include a positional-recognition recess provided thereon in the close vicinity of the image-stabilizer operating member, wherein the positional-recognition recess is tactilely recognizable.

It is desirable for the image-stabilizer operating member to be provided on an upper surface in a vicinity of one end of the camera body, and for the positional-recognition recess to be formed on the upper surface of the camera body between the one end of the camera body and the image-stabilizer operating member.

It is desirable for the camera body to include a positional-recognition projection provided thereon in the close vicinity of the image-stabilizer operating member, wherein the positional-recognition projection is tactilely recognizable.

It is desirable for the image-stabilizer operating member to be provided on an upper surface in a vicinity of one end of the camera body, and for the positional-recognition projection to be formed on the upper surface of the camera body between the one end of the camera body and the image-stabilizer operating member.

According to the present invention, the user can confirm whether or not the image-stabilizing function is effectively functioning via operating an image-stabilizing operation button which is provided as a separate member from the shutter-release button. Furthermore, the user can easily maintain attentiveness in regard to hand-shake, and hence, facilitate secure handling of the camera, and unintentional hand-shake can be reduced to a minimum. Moreover, the user can confirm the extent by which the image-stabilizing function operates before the shutter-release button is depressed (before the shutter is released). Therefore, if a photographic operation is performed with the image-stabilizing function activated, a sharp image having no (negligible) blur is easier to achieve compared to that of a camera having an image-stabilizing function of the prior art.

Furthermore, if the image-stabilizer operating member is constructed so as to be movably biased toward the image-stabilizer-deactivated position by the biasing device, since the image-stabilizing function is only activated while the user holds the image-stabilizer operating member in the image-stabilizer-activated position against the biasing force of the biasing device, the user can discern (confirm) the position of the image-stabilizer operating member not only visually, but also tactilely. Accordingly, the user can more reliably discern whether the image-stabilizing function is activated or not.

In a construction wherein the shutter-release button and the image-stabilizer operating member are provided on mutually opposite sides with respect to an approximate center of the camera body, the user naturally holds the camera at both sides thereof (at the shutter-release button side and the image-stabilizer operating member side). Since image blur is greatly reduced if the camera body is held in such a manner, if the image-stabilizing function is activated during a photographic operation, a photographic image having no blurring is achieved.

The present disclosure relates to subject matter contained in Japanese Patent Application No. 2005-371245 (filed on Dec. 26, 2005) which is expressly incorporated herein in its entirety.

### BRIEF DESCRIPTION OF THE DRAWINGS

The present invention will be discussed below in detail with reference to the accompanying drawings, in which:

FIG. 1 shows a rear perspective view of a camera having an image-stabilizing function, according to the present invention;

FIG. 2 is a sectional view taken along the II-II line shown in FIG. 1;

FIG. 3 is a block diagram showing the mutual relationship between operating members, a photographing optical system, an image device, controllers and an image-stabilization mechanism of the camera having an image-stabilizing function, according to the present invention;

FIG. 4 shows a flowchart of operations during photographing and image stabilization;

FIG. 5 shows an upper left portion of a camera body of a modified embodiment of an image-stabilizer operating member;

FIG. 6 shows an upper left portion of a camera body of another modified embodiment of an image-stabilizer operating member;

FIG. 7 shows a rear upper left portion of a camera body of another modified embodiment of an image-stabilizer operating member.

### DESCRIPTION OF THE PREFERRED EMBODIMENTS

The present invention is described herein with reference to the accompanying drawings.
Firstly, the construction of a camera 10 having an image-stabilization function will be briefly described.

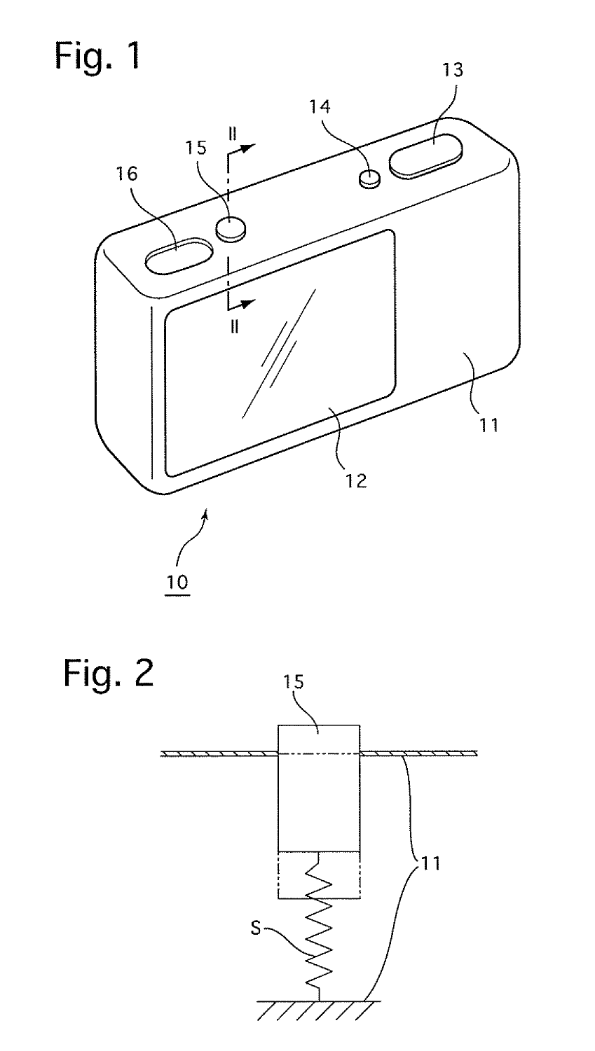

The camera 10 having an image-stabilization function is a digital camera having a LCD panel 12 provided on the back surface of the camera body 11 thereof. A shutter-release button (shutter-release operating member) 13 is provided on the right portion of the upper surface of the camera body 11, and a main switch 14 is also provided on the upper surface of the camera body 11 at the left side of the shutter-release button 13 in the close vicinity thereof. Furthermore, an image-stabilizer button (image-stabilizer operating member) 15 is provided on the upper surface on the left portion of the camera body 11. The image-stabilizer button 15 is a movable member which can be moved to protrude upwards from the camera body 11 and to sink into the camera body 11. Namely, the image-stabilizer button 15 is movable between an image-stabilizer-deactivated position (shown by solid lines in FIG. 2), at which the image-stabilizer button 15 protrudes above the upper surface of the camera body 11, and an image-stabilizer-activated position (shown by phantom lines in FIG. 2), at which the image-stabilizer button 15 is sunk into the camera body 11. Furthermore, the image-stabilizer button 15 is always biased to move toward the image-stabilizer-deactivated position by a compression coil spring (biasing device) S (see FIG. 2) provided in the camera body 11. As shown in FIG. 1, a positional-recognition recess 16 is provided on the left side of the image-stabilizer button 15 on the upper surface of the camera body 11 when viewed from the rear side of the camera 10 (the side at which the LCD panel 12 can bee seen), and is positioned on the outer side of the image-stabilizer button 15 (i.e., on the left end portion of the camera body 11). The positional-recognition recess 16 is larger than that of the image-stabilizer button 15 in a plan view and can by tactilely recognized by the hand (finger) of the user.

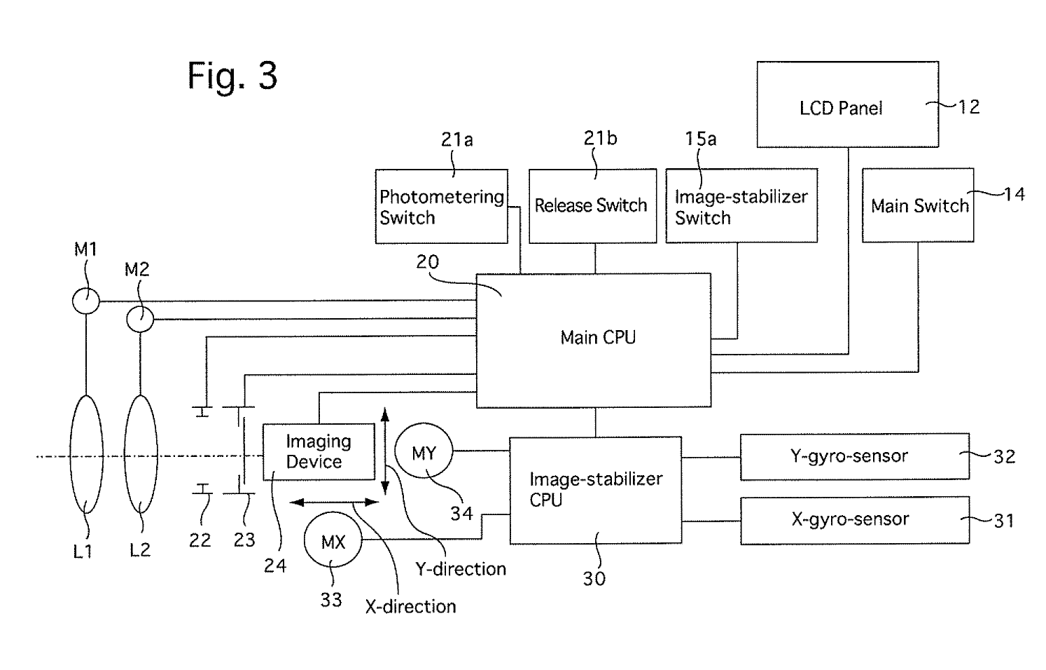

FIG. 3 is a block diagram showing the mutual relationship between various components (optical elements, controllers and image-stabilizing mechanism) which constitute the camera 10 having an image-stabilization function.

The LCD panel 12, the shutter-release button 13, the main switch 14 and an image-stabilizer switch 15a are electrically connected to a main CPU 20. A photometering switch 21a is electrically connected to the main CPU 20. The photometering switch 21a is turned ON via control of the main CPU 20 upon the shutter-release button 13 being depressed by a half step when the photographic mode is in an AF mode. A release switch 21b is electrically connected to the main CPU 20. The release switch 21b is turned ON via control of the main CPU 20 upon the shutter-release button 13 being fully depressed. The image-stabilizer switch 15a is OFF when the image-stabilizer button 15 is positioned at the image-stabilizer-deactivated position, and is ON when the image-stabilizer button 15 is positioned at the image-stabilizer-activated position. A zoom lens L1, a focusing lens L2, a diaphragm 22, a shutter unit 23, and an imaging device 24 are provided in the camera body 11 and a photographing lens barrel (not shown). The diaphragm 22 and the shutter unit 23 are connected to a driving device (not shown). This driving device is electrically connected to the main CPU 20, and operates in association with a diaphragm operation button (not shown) and the shutter-release button 13 so as to operate the diaphragm 22 and the shutter unit 23, respectively. Motors M1 and M2 constitute driving devices for driving the zoom lens L1 and the focusing lens L2, respectively. Motors M1 and M2 are both electrically connected to the main CPU 20, and operate in accordance with an operation of a zoom switch (not shown) and a half-step depression operation of the shutter-release button 13, respectively, so that the zoom lens L1 and the focusing lens L2 move along the optical axis thereof accordingly.

The imaging device 24 is electrically connected to the main CPU 20, and a photographic image which is captured by the imaging device 24 is image-processed by the main CPU 20. The imaging device 24 is supported by the camera body 11 via a stage apparatus (not shown). The imaging device 24 is freely slidable in an X-direction (the left/right direction of the camera body 11) and in a Y-direction (the up/down direction of the camera body 11), which is orthogonal to the X-direction, via an operation of the stage apparatus.

An image-stabilizer CPU 30, an X-gyro-sensor 31, a Y-gyro-sensor 32, an X-direction drive motor 33, a Y-direction drive motor 34, and the above-mentioned stage apparatus constitute components of an image-stabilizing mechanism. The image-stabilizer CPU 30 is electrically connected to the main CPU 20. The image-stabilizer CPU 30 does not function when the image-stabilizer button 15 is positioned at the image-stabilizer-deactivated position, but only functions when the image-stabilizer button 15 is positioned at the image-stabilizer-activated position. The X-gyro-sensor 31 and the Y-gyro-sensor 32 are electrically connected to the image-stabilizer CPU 30. The X-gyro-sensor 31 and the Y-gyro-sensor 32 detect angular velocities about the X-axis and the Y-axis of the camera 10 (camera body 11), respectively, when hand shake (camera shake) occurs in the camera 10. The X-direction drive motor 33 and the Y-direction drive motor 34, which are electrically connected to the image-stabilizer CPU 30, are connected to the above-mentioned stage apparatus, so that imaging device 24 slidably moves in the X-direction when the X-direction drive motor 33 is driven, and the imaging device 24 slidably moves in the Y-direction when the Y-direction drive motor 34 is driven.

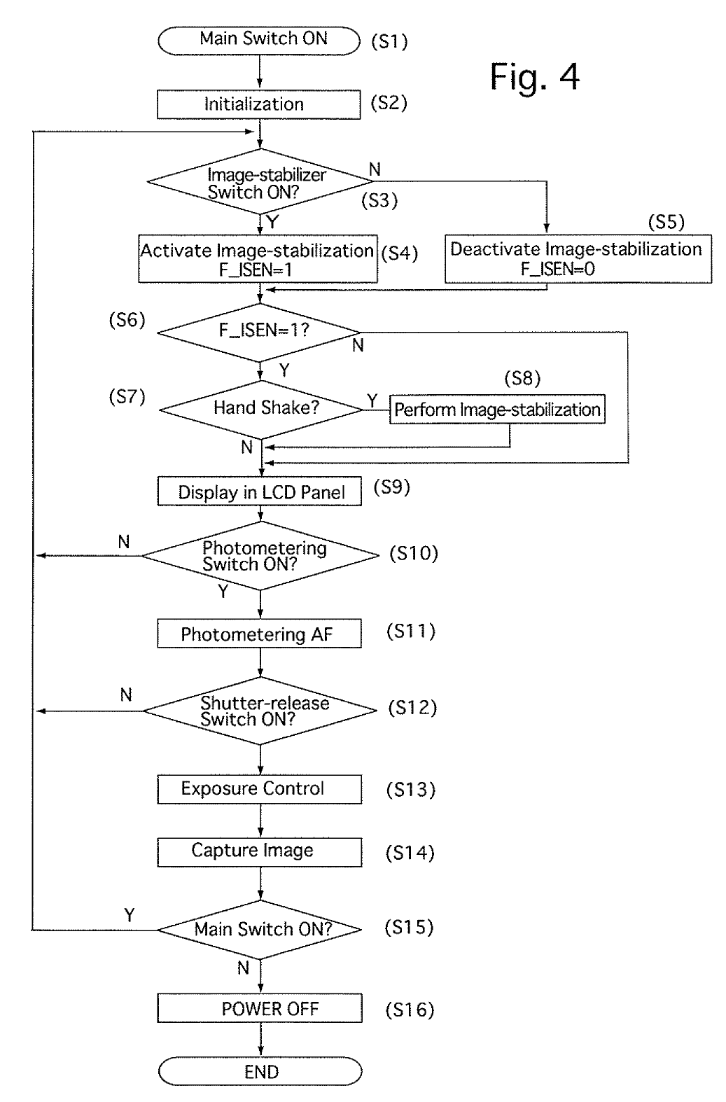

The series of operations (photographing and image stabilizing, etc.) carried out when a photographing operation is performed using the camera 10 having an image-stabilizing function will be described hereinafter with reference to the block diagram of FIG. 4.

The user (photographer) uses his/her right hand to hold the right end portion of the camera body 11, and uses his/her left hand to hold the left end portion of the camera body 11. When the camera body 11 is held in such a manner, since a finger of the left hand is in contact with the positional-recognition recess 16 which is positioned in the close vicinity of the image-stabilizer button 15, the user can become aware of the approximate position of the image-stabilizer button 15 without visually confirming the position thereof. Accordingly, upon the user becoming aware of the position of the image-stabilizer button 15, the user places a finger of his/her left hand onto the image-stabilizer button 15.

When the user depresses the main switch 14 with his/her right hand (finger), the main switch is turned ON (step S1), and the position of the imaging device 24 is initialized (i.e., the center of the imaging surface of the imaging device 24 is aligned with the position of the optical axis of the camera 10) (step S2).

Thereafter, the main CPU 20 determines whether or not the user has depressed the image-stabilizer button 15 down to the image-stabilizer-activated position (whether or not the image-stabilizer switch 15a is ON) by his/her left hand (finger) (step S3).

If the main CPU 20 determines at step S3 that the image-stabilizer button 15 has been depressed down to the image-stabilizer-activated position, a flag ‘F_ISEN ’ is set to 1, i.e., image-stabilizing is permitted (step S4). On the other hand, if the main CPU 20 determines at step S3 that the image-stabilizer button 15 is positioned at the image-stabilizer-deactivated position, the flag ‘F_ISEN ’ is set to 0, i.e., image-stabilizing is not permitted (step S5).

Subsequently, the CPU 20 determines at step S6 whether or not the flag F_ISEN is equal to 1. If the CPU 20 determines that the flag F_ISEN is equal to 1 (i.e., the image-stabilizer button 15 is positioned at the image-stabilizer-activated position) and if at step S7 the image-stabilizer CPU 30 determines that hand-shake is occurring (angular velocities are detected by the X-gyro-sensor 31 and the Y-gyro-sensor 32) in the camera 10 (camera body 11), the image-stabilizer CPU 30 calculates the movement distances (hand-shake amount) in the X-direction and the Y-direction of the camera body based on the detected angular velocities. Furthermore, the image-stabilizer CPU 30 drives the X-direction drive motor 33 and the Y-direction drive motor 34 in accordance with this hand-shake amount, so that the imaging device 24 is moved with respect to the camera body 11 in a direction opposite to the hand-shake direction by the same amount as the hand-shake amount (i.e. image stabilization is performed; step S8). Accordingly, when image stabilization is performed in such a manner, a photographic image captured by the imaging device 24 is displayed in the LCD panel 12 while image-stabilization is carried out (step S9).

On the other hand, if the flag F_ISEN is equal to 1 at step S6, but if at step S7 the image-stabilizer CPU 30 determines that hand-shake has not occurred (angular velocities have not been detected by the X-gyro-sensor 31 and the Y-gyro-sensor 32) in the camera 10 (camera body 11), or if the flag F_ISEN is 0 at step S6, the X-direction drive motor 33 and the Y-direction drive motor 34 do not operate (image-stabilization is not performed), so that the photographic image captured by the imaging device 24 is displayed in the LCD panel 12 without image-stabilization being carried out (step S9).

Accordingly, if the shutter-release button 13 is depressed by half a step (with the photographic mode set to the AF mode) in a state where the image-stabilizer button 15 is either at the image-stabilizer-activated position or the image-stabilizer-deactivated position, it is determined at step S10 that the photometering switch 21a is ON, so that a photometering operation and an autofocusing operation is carried out (step S11). Furthermore, if the shutter-release button 13 is fully depressed, the main CPU 20 determines that the shutter-release button 13 has been fully depressed (i.e. the release switch 21b is ON) in step S12, and upon an exposure control being carried out by the diaphragm 22 (step S13), the imaging device 24 performs an image capturing process (the shutter of the shutter unit 23 is released) (step S14). If an image-stabilizing operation is performed during a photographing operation, i.e., during an exposure operation, a blur-corrected image is captured by the imaging device 24.

If the main CPU 20 determines that the main switch 14 is still ON at step S15, the main CPU 20 again determines whether or not the image-stabilizer button 15 is ON (step S3). On the other hand, if the main CPU 20 determines that the main switch 14 is OFF at step S15, the main power source of the camera 10 is turned OFF (step S16), and control ends.

As described above, since image-stabilization is performed only when the image-stabilizer button 15 is positioned at the image-stabilizer-activated position, for example, when deciding on the composition of the image about to be photographed while viewing the LCD panel 12 before the shutter-release button 13 is depressed, the user (photographer) can reliably recognize whether or not the image-stabilizing function is working both tactilely by the user's hand (finger) and visually. Accordingly, the user can be effectively prevented from forgetting that the image stabilizing function is working, so as to reduce the chance of the amount of hand shake being larger than the capability of the image-stabilizing function of the camera 10. Furthermore, since the image-stabilizing function can be operated before fully depressing the shutter-release button 13, the user can be aware of the extent by which the image-stabilizing function operates during an imaging process (image capture process) before a photograph is taken by viewing the LCD panel 12 before fully depressing the shutter-release button 13.

Furthermore, since the shutter-release button 13 is provided on the right portion of the upper surface of the camera body 11 and the image-stabilizer button 15 is provided on the upper surface on the left portion of the camera body 11, if the user operates the camera 10 (camera body 11) using both left and right hands, the shutter-release button 13 is operated with the right hand and the image-stabilizer button 15 is operated with the left hand. Accordingly, if the shutter-release button 13 is fully depressed while the image-stabilizing function is operated (in a shutter release operation), since both left and right hands hold the left and right portions of the camera body 11, the camera body 11 can be effectively prevented from shaking by a large amount (i.e., a large amount of hand-shake can be prevented) when the shutter-release button 13 is fully depressed by the right hand (finger).

Furthermore, the present invention is not limited to the above-described embodiment. Various modifications of the above-described embodiment are possible.

For example, although in the illustrated embodiment the imaging device 24 is slidably moved in the X-direction and the Y-direction in order to correct hand shake (camera shake), in an alternative embodiment, a correction lens (not shown) can be employed instead of the imaging device 24 and hand shake can be corrected by slidably moving the correction lens in directions orthogonal to the optical axis when the image-stabilizer button 15 is positioned at the image-stabilizer-activated position. Hence, if a correction lens is employed in such a manner, the present invention can also be applied to a silver-halide film camera.

Furthermore, an electronic hand-shake correction system can be employed so that when the image-stabilizer button 15 is positioned at the image-stabilizer-activated position, the imaging device 24 and the main CPU 20 carry out an electronic hand-shake correction operation.

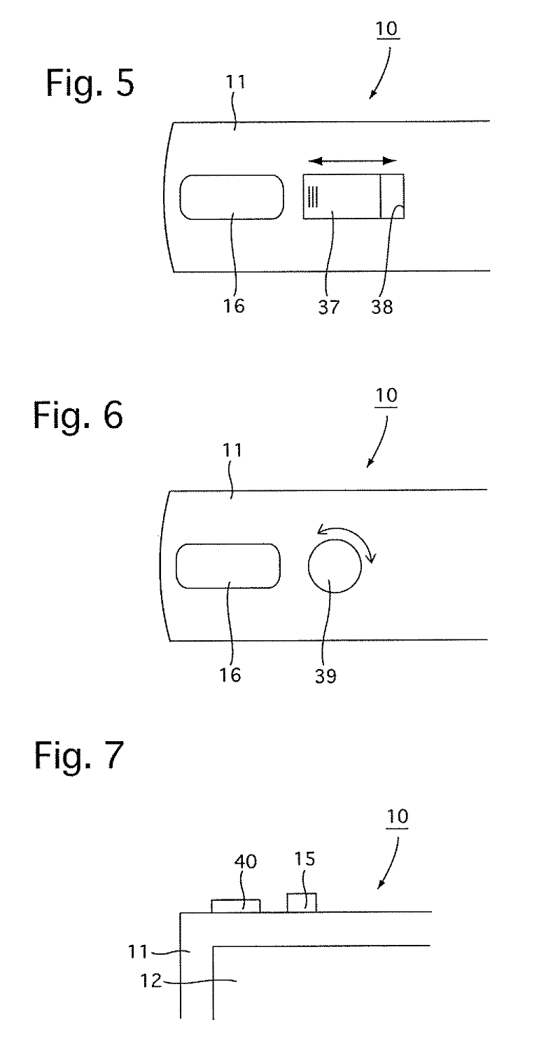

Furthermore, the image-stabilizer button 15 can have an alternative construction. For example, as shown in FIG. 5, a slidable image-stabilizer operating member 37 can be provided on the upper surface on the left portion of the camera body 11. As shown in FIG. 5, an approximately diagonally shaped slide recess 38 is formed on the upper surface on the left portion of the camera body 11, and the image-stabilizer operating member 37, which has smaller dimensions in the left/right direction than that of the slide recess 38, is slidably fitted in the slide recess 38 so as to be slidable in the left and right directions. The position of the image-stabilizer operating member 37 shown in FIG. 5 (positioned at the left end within the slide recess 38) designates the image-stabilizer-deactivated position of the image-stabilizer operating member 37, and a position (not shown) of the image-stabilizer operating member 37 at the right end within the slide recess 38 designates the image-stabilizer-activated position of the image-stabilizer operating member 37. A biasing device (not shown) is also provided in the camera body 11 which biases the image-stabilizer operating member 37 toward the image-stabilizer-deactivated position. The image-stabilizing function is activated only when the image-stabilizer operating member 37 is positioned at the image-stabilizer-activated position, and the image-stabilizing function does not work when the image-stabilizer operating member 37 is positioned at the image-stabilizer-deactivated position.

Alternatively, it is possible to provide the image-stabilizer operating member as a rotational operating member 39 which is rotatably provided (rotatably mounted) on the left portion of the camera body 11, as shown in FIG. 6. In such a case, one rotational limit of the rotational operating member 39 is set as the image-stabilizer-activated position, and the other rotational limit of the rotational operating member 39 is set as the image-stabilizer-deactivated position, and the rotational operating member 39 is always rotationally biased toward the image-stabilizer-deactivated position via a biasing device such as a spring, etc. Accordingly, the image-stabilizing function is only activated when the rotational operating member 39 is positioned at the image-stabilizer-activated position, and the image-stabilizing function does not work when the rotational operating member 39 is positioned at the image-stabilizer-deactivated position.

Furthermore, as shown in FIG. 7, it is possible to alternatively provide a positional-recognition projection 40 in the vicinity of the image-stabilizer button 15 (image-stabilizer operating member 37/rotational operating member 39) instead of the positional-recognition recess 16, so that the user can tactilely recognize the position of the image-stabilizer button 15 (image-stabilizer operating member 37/rotational operating member 39) via the positional-recognition projection 40.

Furthermore, the present invention is not limited to the hand-shake correction device (image-stabilizing mechanism) performing correction only in the X-direction and the Y-direction, the present invention is also applicable to a hand-shake correction device (image-stabilizing mechanism) which can correct rotational shake.

Furthermore, the shutter-release button 13 can be provided on the left portion of the upper surface of the camera body 11, and the image-stabilizer button 15 and image-stabilizer operating member 37 (slide recess 38) or rotational operating member 39 can be provided on the right portion of the upper surface of the camera body 11.

If the shutter-release button 13 and the image-stabilizer button 15 (image-stabilizer operating member 37/rotational operating member 39) are positioned on the upper surface of the camera body 11 on mutually opposite sides with respect to an approximate center of the camera body 11, excessive shaking (an increased amount of hand shake) of the camera body 11 when the shutter-release button 13 is fully depressed can be effectively prevented even if the shutter-release button 13 and the image-stabilizer button 15 are not provided at the left and right end portions on the camera body 11. Accordingly, for example, if the camera body 11 of the camera 10 is long in a forward/rearward direction thereof, in such a case, since either the right hand or the left hand is used to hold the rear portion of the camera body 11 and the other hand is used to hold the front portion of the camera body 11, one of the shutter-release button 13 and the image-stabilizer button 15 (image-stabilizer operating member 37/rotational operating member 39) can be provided on the rear portion of the camera body 11 and the other of the shutter-release button 13 and the image-stabilizer button 15 (image-stabilizer operating member 37/rotational operating member 39) can be provided on the front portion of the camera body 11. According to such a construction, if the shutter-release button 13 is fully depressed while operating the image-stabilizing function, since the left and right hands of the user always hold the camera body 11 at the front and rear portions thereof, the camera body 11 can be effectively prevented from excess shaking when the shutter-release button 13 is fully depressed by the right hand or the left hand of the user.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A camera having an image-stabilizing function, comprising:
an image-stabilizing mechanism which corrects image blur that occurs due to hand shake of said camera;
a shutter-release operating member; and
an image-stabilizer operating member which is operably movable between an image-stabilizer-activated position and an image-stabilizer-deactivated position, said image-stabilizer operating member being provided separately from said shutter-release operating member on a camera body of said camera, wherein
said image-stabilizing mechanism is activated so as to be capable of image stabilization while said image-stabilizer operating member is positioned at said image-stabilizer-activated position,
said image-stabilizing mechanism is deactivated so as to be incapable of image stabilization while said image-stabilizer operating member is positioned at said image-stabilizer-deactivated position, and
said image-stabilizer operating member is biased toward said image-stabilizer-deactivated position so as to be positioned at said image-stabilizer-deactivated position in a free state.

2. The camera having an image-stabilizing function according to claim 1, wherein said image-stabilizer operating member can be moved so as to protrude upwards from said camera body and moved so as to sink downward into said camera body,
wherein said image-stabilizer-deactivated position is a position at which said image-stabilizer operating member protrudes upwards from said camera body, and
wherein said image-stabilizer-activated position is a position at which said image-stabilizer operating member sinks downward into said camera body.

3. The camera having an image-stabilizing function according to claim 1, wherein said image-stabilizer operating member comprises a freely slidable member which is linearly slidable along a surface of said camera body,
wherein one movement extremity of said slidable member corresponds to said image-stabilizer-deactivated position, and the other movement extremity of said slidable member corresponds to said image-stabilizer-activated position.

4. The camera having an image-stabilizing function according to claim 1, wherein said image-stabilizer operating member comprises a freely rotatably rotational operating member which is rotatably movable on said camera body,
wherein one rotational movement extremity of said rotational operating member corresponds to said image-stabilizer-deactivated position, and the other movement extremity of said rotational operating member corresponds to said image-stabilizer-activated position.

5. A camera having an image-stabilizing function, comprising:
an image-stabilizing mechanism which corrects image blur that occurs due to hand shake of said camera;
a shutter-release operating member; and
an image-stabilizer operating member which is operably movable between an image-stabilizer-activated position and an image-stabilizer-deactivated position, said image-stabilizer operating member being provided separately from said shutter-release operating member on a camera body of said camera, wherein
said image-stabilizing mechanism is activated so as to be capable of image stabilization while said image-stabilizer operating member is positioned at said image-stabilizer-activated position,
said image-stabilizing mechanism is deactivated so as to be incapable of image stabilization while said image-stabilizer operating member is positioned at said image-stabilizer-deactivated position, and
wherein said shutter-release operating member and said image-stabilizer operating member are provided on said camera body at opposite sides thereof with respect to an approximate center of said camera body.

6. The camera having an image-stabilizing function according to claim 5, wherein one and the other of said shutter-release operating member and said image-stabilizer operating member is provided on right and left end portions of an upper surface of said camera body, in a plan view.

7. The camera having an image-stabilizing function according to claim 1, wherein said camera body comprises a positional-recognition recess provided thereon in the close vicinity of said image-stabilizer operating member, wherein said positional-recognition recess is tactilely recognizable.

8. The camera having an image-stabilizing function according to claim 5, wherein said camera body comprises a positional-recognition recess provided thereon in the close vicinity of said image-stabilizer operating member, wherein said positional-recognition recess is tactilely recognizable.

9. The camera having an image-stabilizing function according to claim 7, wherein said image-stabilizer operating member is provided on an upper surface in a vicinity of one end of said camera body, and
wherein said positional-recognition recess is formed on said upper surface of said camera body between said one end of said camera body and said image-stabilizer operating member.

10. The camera having an image-stabilizing function according to claim 1, wherein said camera body comprises a positional-recognition projection provided thereon in the close vicinity of said image-stabilizer operating member, wherein said positional-recognition projection is tactilely recognizable.

11. The camera having an image-stabilizing function according to claim 10, wherein said image-stabilizer operating member is provided on an upper surface in a vicinity of one end of said camera body, and
wherein said positional-recognition projection is formed on said upper surface of said camera body between said one end of said camera body and said image-stabilizer operating member.
